(19) United States
(12) Patent Application Publication
(10) Pub. No.: US 2022/0267213 A1
(43) Pub. Date: Aug. 25, 2022

(54) TWO COMPONENT REPAIR MATERIAL

(71) Applicant: SIKA TECHNOLOGY AG, Baar (CH)

(72) Inventors: Mohamed CADER, Cranford, NJ (US); Nikitas TSIRIGOTIS, Miles City, MT (US); Andrea LUCERO, Rutherford, NJ (US); Fernando ARELLANO, Clifton, NJ (US)

(73) Assignee: SIKA TECHNOLOGY AG, Baar (CH)

(21) Appl. No.: 17/675,537

(22) Filed: Feb. 18, 2022

Related U.S. Application Data
(60) Provisional application No. 63/151,271, filed on Feb. 19, 2021.

(51) Int. Cl. C04B 28/14; C04B 18/02; C04B 14/36; C04B 24/26; C04B 40/00

(52) U.S. Cl. CPC C04B 28/14; C04B 18/021; C04B 14/363; C04B 24/2676; C04B 40/0042; C04B 2111/72

(57) ABSTRACT

A two-component repair material comprising or consisting a first component A comprising a hydraulic binder, and aggregate, and a second component B comprising an aqueous emulsion of bitumen and at least one synthetic polymer. Especially, the repair material is for repair of asphalt-based construction materials.

### CROSS-REFERENCE TO RELATED APPLICATIONS

This application claims the filing date benefit of U.S. Provisional Application No. 63/151,271, filed on Feb. 19, 2021, the entirety of which is incorporated by reference herein.

### TECHNICAL FIELD

This disclosure relates generally to a two-component repair material comprising a first component A comprising a hydraulic binder and aggregate, and a second component B comprising an aqueous emulsion of bitumen and at least one synthetic polymer. More specifically, the repair material is for repair of asphalt-based construction materials.

### BACKGROUND

Asphalt is a major material for modern construction. Roads, sidewalks, roofs and many more structures are made from asphalt-based materials or at least covered with layers of asphalt or bitumen. As these buildings are outside and exposed to environmental stress and where roadways and surfaces are trafficked, repairs will be necessary with time. Suitable repair materials can be based on bitumen or asphalt. Suitable repair materials generally adhere well to the construction materials being repaired, cure quickly, have increased resistance to loads and/or weathering, and are visually appealing (e.g. reduced blushing) among others.

Existing bitumen emulsion-based repair materials have the drawback of curing slowly. Therefore, these products must be applied in a thin layer and cannot be used to fill deep holes. In addition, they are tacky after application.

DE 10 2014 001 079 is concerned with a two-component waterproofing material consisting of a liquid component consisting of an anionic bitumen emulsion with 50-65% solids content and an anionic polymer dispersion with 35-65% solids content, as well as a powder component consisting of a mineral sealing slurry. This waterproofing material may harden within 24 h and further layers can then be applied.

There is a general need for further repair materials for asphalt-based construction materials, especially on trafficked surfaces. Preferably such materials will show adhesion to the construction materials being repaired, will cure quickly, have increased resistance to loads and/or weathering, and be visually appealing (e.g., having reduced blushing).

### SUMMARY

Traditionally, the asphalt products on the market have a tendency to crack, which is believed to be caused by the presence of water within the cured asphalt emulsion. Surprisingly, in some aspects, the inventive composition is not prone to cracking. This is believed to be caused by the use of a relatively higher portion of synthetic polymer in the bitumenous portion of the material in some aspects of the invention than was previously used, which may consume the water in the asphalt emulsion. In addition, the bitumen is flexible and provides dimensional stability, weatherproofing, and adhesion to substrate

Surprisingly, the inventors found that when the amount of bitumen emulsion was increased, the blushing became less prominent. Blushing became less noticeable in a range of 550-650 mass parts of a component B according to the present invention, especially of 550-725 mass parts of bitumen emulsion, relative to 1872 mass parts of a component A of the present invention. Blushing was more prominent where 500 mass parts or less of a component B were used relative to 1872 mass parts of a component A. bitumen emulsion in the final mix design. The inventors also found that carbon black did not improve blushing (or final surface color) and could potentially enhance blushing. The use of inorganic oxide pigments such as iron oxide and manganese iron ferrite (a CICP) reduced the amount of blushing and improved rheology (increased viscosity) without having a drastic reduction in mixability. Without intending to be bound by theory, it is believed that the finely ground inorganic pigments may help oxidize or cure the synthetic polymer that contributes to the blushing while secondarily adding to richness of the surface color. Regardless, in embodiments, the inorganic oxide pigments of fine particle size, less than 1 micron reduced the presence of blushing and deepened the black bitumen color of the finished material.

If the % bitumen emulsion or component B was increased by an undesirable amount, the system had poor rheologies. In particular, the final composition was too “wet” and hard to mix and had significant settling of the aggregate material, the composition had a smoother finished texture (which is undesirable), and more time was needed for the bitumen to firmly cure on the surface of the material. Since the cementitious material improves the finished tackiness and softness (by lessening it), having too much bitumen emulsion can be undesirable.

It is an objective of the present invention to provide a repair material for asphalt-based construction materials.

In some aspects, one advantage of the repair material is that components A and B are consistently mixable. As there is little variation in mixability from batch to batch, application is greatly facilitated.

In some aspects, another advantage of the repair material is that it allows for the surface to be dry shortly after application. Also, the repair material can be applied in deep sections of the construction material.

In some aspects, another advantage is the repair material limits blushing, while improving durability, adhesion, and waterproofing. Also, because of the content of hydraulic binders, wear is limited.

The compositions and methods disclosed herein can achieve advantageous compressive strength, adhesion, waterproofing, tackiness of set material, turnaround time for use after application, ability to cure, and flexural strength (i.e. tendency to crack) compared to current solutions, while maintaining a product that is not as prone to effloresce and that is an aesthetically similar product upon application and during wear (in terms of color, texture and touch due to the asphalt emulsion) as to pre-existing asphalt/pavement being repaired or refurbished by the user. The product can be applied to deep and shallow depressions with or without an edge. The use of two binders, cement and bitumen, allow the combination of the benefits of both materials in one product.

Additionally, the approach of using a two component pouch or other two component container, in which component A is in one container and component B is in a second container, allows this product to be used by do-it-yourself (DIY) users and small contractors that need to fix small patches with a cold mix asphalt.

In one aspect, this disclosure provides a two-component repair material that includes a first component A and a second component B. The first component A includes

(a) 7-100 w % of a hydraulic binder based on the total weight of component A, and (b) 0-93 w % of aggregates based on the total weight of component A, and the second component B includes
(d) an aqueous emulsion of bitumen, and
(e) at least one synthetic polymer in an amount of greater than 0 and lower than about 30 w % based on the total weight of the second component B.

In another aspect, this disclosure provides a mixture of the component A and component B, where the mixture is mixed with a ratio of the first component A and the second component B such that the mixture includes approximately 10-45 w % of the hydraulic binder.

In another aspect, this disclosure provides a process for treating a porous construction material, which includes (i) providing the first component A and the second component B, (ii) mixing the first component A and the second component B to obtain a mixture; and (iii) applying the mixture to the porous construction material.

In still another aspect, this disclosure provides a kit that includes a first container that includes the first component A, and a second container that includes the second component B.

### DETAILED DESCRIPTION

Within the present context the expressions “bitumen” and “asphalt” are used interchangeably and relate to the same materials.

In a first aspect the present invention relates to a two-component repair material comprising a first component A and a second component B, said first component A comprising or consisting of (in each case relative to the total weight of component A)

a) 7-100% by weight, preferably 10-55% by weight, more preferably 16-36% by weight of a hydraulic binder,
b) 0-93% by weight, preferably 45-90% by weight, more preferably 66-80% by weight of aggregates, and
c) optionally further additives
and said second component B comprising or consisting of
d) an aqueous emulsion of bitumen, and
e) at least one synthetic polymer in an amount of greater than 0 and lower than about 30% by weight, preferably between 3-25% by weight, more preferably between 8-20% by weight, especially between 14-20 w %, relative to the total weight of the component B.

The two-component repair material of the present invention comprises or consists of a first component A and a second component B. Component A and component B are stored in separate compartments. Mixing of the component A and the component B to form a repair material of the present invention is preferably done at the place of usage and shortly before the planned usage. This is because upon mixing the component A and the component B the mixed composition begins to harden.

The hydraulic binder in component A preferably is selected from Portland cement, aluminate cement, calcium sulfoaluminate cement, a source of calcium sulfate, natural hydraulic lime, slag, pozzolanes, and mixtures thereof.

Portland Cement within the present context is understood to mean a cement of the type CEM I, CEM II, CEM III, CEM IV or CEM V according to standard EN 197-1:2018-11. A Portland cement can also be a mixture of these cement types. Portland cements described in alternative standards, e.g. ASTM C150-00, are equally suitable. The clinker content in a Portland cement is preferably at least 65% by weight, based on the total dry weight of the cement. In certain embodiments of the present invention, the clinker content is at least 80% by weight, based on the total dry weight of the cement. According to some embodiments, the Portland cement used in a hydraulic binder is a CEM I according to EN 197-1:2018-11.

An aluminate cement within the present context is a cement with a main phase consisting of hydraulic calcium aluminates, preferably being CA, i.e., CaO.Al₂O₃. Depending on exact type of the aluminate cement, other calcium aluminates such as CA₂, C₃A, C₁₂A₇ are also present. Aluminate cements used in embodiments of the present invention typically also contain other phases selected from belite (C₂S), tricalcium silicate, ferrites (C₂F, C₂AF, C₄AF) and ternesite, i.e., Ca₅(SiO₄)₂SO₄ (C₅S2_{$}). The aluminate cements may further comprise calcium carbonate. In particular, an aluminate cement of the present invention complies with EN 14647:2006-01. Calcium aluminate cement (CAC) is a particularly commonly used type of aluminate cement and is specifically preferred in the context of some embodiments of the present invention. Suitable aluminate cements can be obtained commercially, for example, from Kerneos SA or Royal White Cement.

A calcium sulfoaluminate cement is a cement with a main phase consisting of C₄(A₃₋ₓFₓ)₃$ (4 CaO.3−x Al₂O₃.x Fe₂O₃.CaSO₄) where x is an integer of from 0-3. CSA cements that may be useful in embodiments of the present invention typically comprise further phases selected from aluminates (CA, C₃A, C₁₂A₇), belite (C₂S), ferrites (C₂F, C₂AF, C₄AF), ternesite (C₅S₂$) and anhydrite. In the present context C stands for CaO, A stands for Al₂O₃, F stands for Fe₂O₃, and $ stands for CaSO₄. According to certain embodiments, CSA cements of the present invention comprise 20-75 w %, preferably 25-50 w % C₄A₃$, 0-10 w %, preferably 1-5 w % aluminates, 0-70 w %, preferably 1-50 w % belite, 0-35 w %, preferably 1-10 w % ferrites, 0-20 w %, preferably 1-10 w % ternesite, 0-50 w %, preferably 5-45 w % anhydrite, and 0-25 w % CaO, preferably 1-20 w % CaO, each based on the total dry weight of the CSA cement. However, the use of calcium sulfoaluminate cement may be generally less preferred in some embodiments.

In embodiments, the source of calcium sulfate preferably is selected from anhydrite (CaSO₄), calcium sulfate hemihydrate (CaSO₄.½H₂O), calcium sulfate dihydrate (CaSO₄.2H₂O) or mixtures thereof. Here, the calcium sulfate hemihydrate includes the α-calcium sulfate hemihydrate and the β-calcium sulfate hemihydrate. Calcium sulfate may be based on FGD gypsum, phosphogypsum, as well as natural gypsum. In some embodiments, the source of calcium sulfate is anhydrite.

The term natural hydraulic lime (NHL) refers to materials derived solely from mineral deposits and naturally containing all elements (usually limestone, clay and impurities) to produce a hydraulic lime in a calcination process, typically at temperatures between 800 and 1200° C. Natural hydraulic lime may act as a hydraulic binder in mortar compositions. NHL in the context of the present invention belongs to any of the classes NHL2, NHL3.5 or NHL5 according to EN 459-1:2015, preferably to classes NHL3.5 or NHL5, more preferred to class NHL5.

A slag can be a slag from iron making processes and/or steel making processes. Especially, the slag is selected from ground granulated blast furnace slag, basic oxygen furnace slag, ladle slag and/or electric arc furnace slag, preferably from ground granulated blast furnace slag and/or basic oxygen slag.

The term pozzolane stands in particular for type II concrete additives with latent hydraulic and/or pozzolanic character according to EN 206-1. The term pozzolane thus also encompasses latent hydraulic materials. In particular, pozzolanes are selected from fly ash, silica fume, microsilica, clay minerals, metakaolin, rice husk ash, burnt shale, pumice, and/or trass.

The inventors also studied the effect of adding pozzolans to reduce blushing and whitening and found the following: all pozzolans were found to increase the viscosity and the demand for the bitumen emulsion, creating a need to add more asphalt emulsion in order to completely mix and make fluid the finished composition.

Surprisingly, the result of adding pozzolans and increasing the demand for bitumen emulsion was a decrease in blushing. This was counterintuitive and unexpected because increasing the amount of asphalt emulsion also increased the water content, since the bitumen emulsion contains 25-90 w % water, which conventionally associated with increasing blushing due to increasing moisture content. The decrease in blushing was thought to be primarily due to an increase in the amount of asphalt emulsion, which could be acting as a waterproofing and compete with presence at the surface.

When used in moderate doses, an increase in pozzolans (and at times an increase in bitumen emulsion, where necessary to maintain acceptably mix and flow) also improved the rheological profile, without substantially adding to the amount of reactive cementitious material, resulting in improved rheology without significantly shortening the set time or adding to bleeding. In some aspects, a shorter set time may have been unwanted because the set time may be too short (e.g., less than 5 minutes) for a person using the invention to apply the composition as contemplated in this patent application.

It is possible that the hydraulic binder used in the repair material comprises or consists of a mixture of two or more of Portland cement, aluminate cement, calcium sulfoaluminate cement, a source of calcium sulfate, natural hydraulic lime, slag, and/or pozzolanes. According to some embodiments, the hydraulic binder is a binary binder comprising or consisting of Portland cement and aluminate cement or calcium sulfoaluminate cement, preferably aluminate cement. According to other embodiments, the hydraulic binder is a binary binder comprising or consisting of Portland cement and a source of calcium sulfate. According to further embodiments, the hydraulic binder is a binary binder comprising or consisting of Portland cement and natural hydraulic lime. According to still further embodiments, the hydraulic binder is a ternary binder comprising or consisting of Portland cement, aluminate cement or calcium sulfoaluminate cement, preferably aluminate cement, and a source of calcium sulfate.

According to some embodiments, the hydraulic binder of component A is a ternary binder comprising or consisting of:

a1) 2-100, preferably 10-50 mass parts of Portland Cement,
a2) 5-150, preferably 10-50 mass parts of aluminate cement, and
a3) 1-20, preferably 3-10 mass parts of a source of calcium sulfate.

In a ternary binder, the source of calcium sulfate can be anhydrite.

The term aggregate as used herein means a particulate material that does not participate in the hydraulic reaction. Examples for aggregates include sand, gravel, slag, and crushed stone such as for example crushed limestone or crushed dolomite. Aggregates can be characterized by their granulometry, which can be measured for example by sieve analysis according to standard DIN 66165-2:2016.

Aggregates can be any materials known to the person skilled in the art. Examples for aggregates comprise but are not limited to sands, preferably silica sands, quartz sands, river sands, crushed rocks, preferably crushed carbonate materials, specifically crushed limestone, chalk and/or marble, and/or gravel. In some embodiments, aggregates to be used in the repair material are sands and/or calcium carbonate. According to some embodiments, mixtures of two or more different aggregates can be used in the repair material. Aggregates may differ in their chemical composition and/or in their granulometry. A particularly preferred combination of aggregates is sand and calcium carbonate.

Aggregates that can be used in the repair material may be characterized by a granulometry with a grain size between 0.01 and 10 mm, 0.05 and 5 mm, or between 0.06 and 1 mm, meaning that less than 1% of aggregate used has a particle size outside the given ranges when measured according to DIN 66165-2:2016.

Component A can comprise at least one aggregate in 20-80 mass parts, preferably 30-50 mass parts, each based on the total dry weight of the component A. The aggregate can be selected from sand, crushed rock, limestone flour, lightweight aggregate, especially slate, pumice, or ground rubber, or mixtures thereof.

Component A of the repair material may further comprise other substances such as but not limited to non-reactive fillers (e.g. very fine calcium carbonate), fibers (e.g. cellulose fibers, glass fibers and/or PE fibers), rheology modifiers (especially layered silicates), plasticizers (especially polycarboxylate ethers), defoamers, accelerators, retarders, pigments, chromium VI reducers, biocides, wetting agents, and/or de-dusting additives. According to one embodiment, the component A additionally comprises a plasticizer, preferably a polycarboxylate ether. Polycarboxylate ethers are especially suitable if a repair material is applied by a continuous spray application as defined below. This ensures that mixing with water and pumping through hoses is possible without problems. According to another embodiment, the component A additionally comprises a de-dusting additive which is a hydrocarbon. This ensures that less dust is emitted during handling and especially mixing of the component A and the component B. A de-dusting additive is particularly suitable if the component A is a dry composition in powder form. According to yet other embodiments, the component A comprises a filler, preferably fine limestone, and an accelerator selected from the group consisting of aluminium sulphate and alkali metal or alkaline earth metal nitirite, nitrate, thiocyanate, oxide, hydroxide, carbonate, and silicate.

Component B comprises or consists of an aqueous emulsion of bitumen.

According to some embodiments, the aqueous emulsion of bitumen of the present invention is an anionic aqueous emulsion of bitumen. Preferably, the aqueous emulsion of bitumen, especially the anionic aqueous emulsion of bitumen, is an emulsion of bitumen in water. In other words, the continuous phase of the emulsion preferably is water. An anionic aqueous emulsion is an emulsion where the droplets of the dispersed phase carry a negative charge. Preferably the negative charge is brought about by the presence of anionic surfactants.

According to embodiments, the content of asphalt or bitumen in the aqueous emulsion of bitumen, preferably in the anionic aqueous emulsion of bitumen, is 10-75 w %, 12-60 w %, 12-40 w %, or 15-20 w %, in each case based on the total weight of the emulsion. It has been found that when the content of bitumen in the component B is lower than 10 w % the waterproofing properties are not achieved. It has been further found that when the content of bitumen in the component B is higher than 40 w % the flow properties of the repair material are reduced and application becomes more difficult.

One embodiment of an aqueous emulsion of bitumen is an anionic aqueous emulsion of bitumen with 10-70 w %, 12-60 w %, 12-40 w %, or 15-20 w %, in each case based on the total weight of the emulsion, of bitumen, and where the particle size of the emulsified droplets is such that at least 99% are smaller than 150 μm.

According to embodiments, the aqueous emulsion of bitumen is comprised in a component B in an amount of greater than about 70% by weight, e.g., 80 to 92%, by weight, relative to the total weight of the component B.

Synthetic polymers that can be used in component B are polymers which can be produced by polymerization of suitable monomers. Suitable monomers are selected form the group consisting of ethylene, propylene, butylene, isoprene, butadiene, styrene, acrylonitrile, acrylic acid, methacrylic acid, esters of acrylic acid, esters of methacrylic acid, vinylesters, vinylchloride, vinyl alcohol, and combinations thereof. The synthetic polymers can be copolymers synthesized from two or more, preferably two, different monomers. In some embodiments, preferred are copolymers based on vinyl esters, ethylene and/or acrylic acid esters.

In some embodiments, preferred synthetic polymers are copolymers of vinylacetate and ethylene, vinylacetate and ethylene and methylmethacrylate, vinylacetate and ethylene and vinylester, vinylacetate and ethylene and acrylic acid ester, vinylchloride and ethylene and vinyllaureate, vinylacetate and vinylversatate, acrylic ester and styrene, acrylic ester and styrene and butadiene, acrylic ester and acrylonitrile, styrene and butadiene, acrylic acid and styrene, methacrylic acid and styrene, styrene and acrylic acid ester, styrene and methacrylic acid ester. It is possible and in certain cases preferred to use mixtures of more than one of the said synthetic polymers in the repair material compositions.

Synthetic polymers that can be used in component B can be used in liquid form such as dispersions of synthetic polymer in solvents, preferably in water. The solid content of such polymer dispersions can vary between 20 w % and 75 w %, based on the weight of the dispersion. Suitable dispersions are for example available from BASF SE under the trade name Acronal or from Synthomer plc under the trade name Revacryl.

Synthetic polymers used in component B can also be used in solid form such as for example as redispersible polymer powders. The term redispersible polymer powder refers to a powder which contains a polymer and after introduction into water forms a stable dispersion. A redispersible polymer powder encompasses not only the polymer but typically also mixtures thereof with e.g. protective colloids, emulsifiers, and support materials. Such redispersible polymer powders can be manufactured for example by spray drying of polymer dispersions as for example described in patent application EP1042391. Suitable redispersible polymer powders are for example available from Wacker Chemie AG under the trade name Vinnapas. The use of redispersible powders of synthetic polymers may be preferred in some embodiments.

Accordingly, in some embodiments of the present invention, the synthetic polymer is in the form of a redispersible polymer powder.

The glass transition temperature (Tg) of said synthetic polymers can vary in a wide range. The polymer can be soft and flexible and has a glass transition temperature of −45° C.-+10° C., −35° C.-+5° C., −25° C.-0° C., −20° C.-0° C., or −20° C.-−10° C. In some embodiments, redispersible polymer powders used as the synthetic polymer can have these glass transition temperatures. The Tg of polymers can be measured for example by dynamic mechanical analysis.

According to embodiments, the synthetic polymer can be a redispersible powder comprising a copolymer of vinyl acetate and ethylene with a glass transition temperature of between −45° C.-+10° C., preferably −20° C.-0° C.

According to embodiments, the synthetic polymer can have a minimal film forming temperature of between −5° C. and +10° C.

Component B can comprise at least one synthetic polymer in an amount higher than 0 and lower than about 30% by weight, e.g., between 3-25% by weight or between 8-20% by weight or 14-20% by weight, relative to the total weight of the component B.

Component B may additionally comprise water.

In general, it is believed that overdeveloping the system with too much bitumen emulsion results in a product that has too much water. Also over hydrating of the cement can lead to obvious performance issues typically associated with cement products. In addition, using too much bitumen emulsion can lead to bleeding and a product that has poor rheology by virtue of being too thin, which results in significant settling of aggregate. In some embodiments, it has been discovered that the use of synthetic polymers as described above (also called latex polymers) can overcome these issues. The amount of synthetic polymers is indirectly proportional to the amount of bitumen emulsion, and when used in an ample amount (depending on the quality and ratio of ingredients used in the bitumen emulsion), the consistency of the mix or finished product is greatly improved. The addition of the synthetic polymers in a bitumen emulsion cement mix is similar and analogous in many ways to the affect from adding a plasticizer to cement.

The synthetic polymer to asphalt emulsion balance is important for both mixability and consistency of both mixability and producing an engineered product. If the product does not mix, and is too dry, it will not be able to among many other things build compressive strength and have proper adhesion

The inventors have also discovered that increasing the amount of asphalt emulsion allows the blushing to decrease.

Perhaps most surprising was the discovery that the addition of only greater than 0% to less than 30% by weight of synthetic polymers, e.g., 3-25% or 8-20% by weight, or 14-20% by weight has a positive impact on the mix time and mixability of the finished composition or two components to create the asphalt-cement mix and its engineered properties. In this regard, it is surprising that the aforementioned amount of a latex polymer can be added to produce a consistent asphalt mix, accounting for variability in the asphalt emulsion, due to production variances, feedstock, shelf life or aging, and reactivity (often based on particle size/surface area) and aging of the cementitious material. Although some aspects of this disclosure provide examples of this latex being added to the liquid component, it is expected that similar results will be achieved if it is added as a dry powder to the cementitious powder mix of component A.

The inventors also discovered that the ratio of latex to asphalt emulsion in the component B is inversely proportional in terms of the ratio necessary to create a suitably mixed or consistent mixed finished asphalt-cement mix. As the amount of latex increases, the demand for asphalt emulsion decreases and the overall amount of the liquid portion or component B also decreases. In many ways, the latex was analogous to the addition of a plasticizer to cement mortars.

Latex also serves to improve adhesion and waterproofing of the finished material.

The latex is thought to add to the shelf life of the finished material. Since asphalts can degrade over time and asphalt emulsion can destabilize over time, the addition of a latex polymer allows a finished product to be created that has more consistent mixability after sitting on the shelf for extended periods of time.

The addition of the water-based latex having a positive impact on performance without causing any negative impact to the integrity of the product was surprising for multiple reasons as follows:
1) The use of the latex to improve consistency in a finished engineered material from batch to batch and over long storage periods was not previously known.
2) Of more than 10 manufacturers of asphalt emulsion, 9 manufacturers did not have a product guaranteed to remain stable and not age after more than a few days to three weeks. One company said their product remained stable after a few weeks, but that no shelf life testing had been performed on the product because the product tanks were rotated every few weeks as the product is sold to customers for immediate field application. In order to service the retail market, a product should generally remain useable after being placed in a finished package for upwards of 0-12 months and upwards of two years. The company could also not speak to the aging effect of the product and how that might affect performance with cementitious material. Since these companies supply bulk construction crews that adjust the mix ratio of asphalt and aggregate, a consistent product that remains stable with limited to no change in performance and that is mixed with a hydraulic cement or SCM was not previously a consideration for the major manufacturers. In this regard, these companies usually mix the asphalt and aggregate in the absence of cementitious material, and not typically more than 7% Portland cement, or often not treated beyond the surface, let alone a ternary cementitious system.
3) Previous testing demonstrates that adding water, in as much as 10-20% or more or less, at times will induce cracking in the finished product. However, the amount of water based latex polymer, which as a liquid additive contains water, does not impart cracking on the finished material.

In addition to the advantage of using a latex to create a product that has reproducible results or consistent product, an asphalt cementitious mix can adhere to either/both pre-existing asphalt and/or pre-existing cement/concrete/mortar surfaces or materials during repair or new construction of surfaces.

It is furthermore possible to add further additives to the component B. Such further additives may be selected from additives commonly found in asphalt emulsions, including surfactant, clay, and other stabilizer, rheology modifier, and pen modifier.

The first component A and/or the second component B may additionally contain a pigment.

In addition, the use of supplementary cementitious materials and pigments allows the inventor to optimize the ratio of asphalt emulsion to cementitious mix by increasing the amount of bitumen emulsion without having significant settling or bleeding—this is because the rheologies are improved by having a more viscous product. By increasing the amount of bitumen, by increasing the viscosity, and by increasing the amount of non-cementitious materials (e.g. pozzolan) the discoloration and blushing is reduced. These two products also allow for more bitumen emulsion and more controlled mixability profiles (similar to the addition of latex) which could lead to lower amounts of latex.

Color additives can be added to improve the color, improve the rheology, or require an increase in component A relative to component B. Though the color additive may vary, preferably finely ground inorganic oxides or CICP oxides are the preferred embodiment of a pigment. Pigment additives are typically used in a range of 1-6% by weight, though the range may be higher or lower depending on the finished product, the source of other materials, and the mixability

According to embodiments, the mixture of the first component A and the second component B has non-sag properties. The term non-sag properties relate to the ability of said mixture not to flow down or drip when applied on surfaces with an inclination or overhead at 23° C. and 1013 mbar.

The mix ratio of component A and component B is not particularly limited. However, according to certain embodiments, the mix ratio of component A to component B can such that the final mix comprises approximately 10-45 w %, 12-36 w %, or 16-24 w % hydraulic binder.

In some embodiments, the mix ratio of B to A can be 1:20-1:2, 1:10-1:3, or about 1:5. Any mix ratio that results in a product that is able to have flow and be homogeneously mixed is sufficient. Having more component A also decreases the cost of the finished product and limits the flow to be too thin of a product, which could result in bleeding and other issues.

In another aspect, embodiments of the invention include a process for the repair or waterproofing of asphaltic construction materials, said process comprising the steps of
providing a first component A and a second component B, said first component A comprising or consisting of (in each case relative to the total weight of component A)
   a) 7-100% by weight, 10-55% by weight, or 16-36% by weight of a hydraulic binder,
   b) 0-93% by weight, 45-90% by weight, of 66-80% by weight of aggregates, and
   c) optionally further additives,
   and said second component B comprising or consisting of
   d) an aqueous emulsion of bitumen, and
   e) at least one synthetic polymer in an amount of greater than 0 and lower than about 30% by weight, or between 3-25% by weight, preferably 8-20% by weight, especially 14-20% by weight, relative to the total weight of the component B,
mixing said first component A and said second component B,
applying the mixture thus obtained to a porous construction material, and
optionally hardening the applied mixture.

In other embodiments, the invention provides a process for the repair or waterproofing of porous construction materials by applying to the construction material the mixed component A and component B as described above, characterized in that the hydraulic binder is a ternary binder comprising or consisting of

a1) 20-50, or 30-40 mass parts of Portland Cement,
a2) 20-50, or 30-40 mass parts of aluminate cement, and
a3) 10-50, or 15-40, or 20-30 mass parts of a source of calcium sulfate, and the component B comprises or consists of an anionic aqueous emulsion of bitumen in an amount of greater than about 70% by weight or greater than about 80% by weight, in each case relative to the total weight of the component B.

Methods and devices for mixing of component A and component B of the repair material are not particular limited and are known to the person skilled in the art. It is for example possible to mix component A and component B of a repair material of the present invention by means of a hand held agitator, Hobart mixer, portable concrete mixer, mixing truck, mixing bucket, paddle mixer, jet mixer, screw mixer, auger mixer, horizontal single shaft mixer, twin shaft paddle mixer, vertical shaft mixer, ribbon blender, orbiting mixer, change-can mixer, tumbling vessel, vertical agitated chamber or air agitated operations. Mixing can be continuously, semi-continuously or batch-wise. Continuous mixing offers the advantage of a high material throughput.

It is possible to apply said mixture of component A and component B by any means known to the person skilled in the art. According to one embodiment, the mixture of component A and component B is applied by trowel, brush or roller. According to another embodiment, the mixture of component A and component B is applied in a spray application.

Spray applications have the advantage that the application can be done very quickly and in a continuous manner. Suitable equipment for such spray applications is known to the person skilled in the art. According to one embodiment, a process of the present invention can be run in a continuous manner. Such process is characterized in that of component A and component B are mixed continuously and are supplied to a spray head in a continuous manner. This allows for a continuous spray application. According to these embodiments, the mixture of component A and component B is thus applied in a spray application, preferably a continuous spray application.

In some embodiments, the process may also comprise a second or third step of applying the mixture of component A and component B to a porous construction material. It is, in other words, possible to apply the mixture of component A and component B in a process of the present invention in one layer, in two layers or in three layers.

Hardening starts upon mixing of the component A and the component B and proceeds with time. Physical properties, e.g. compressive strength, adhesion strength, etc. are developed thereby. A mixture of component A and component B will harden at various temperatures. In some cases, it may be preferred to harden the mixture of component A and component B at temperatures between +4° C. and +50° C., or between +5° C. and +35° C. Some embodiments thus are carried out at temperatures between +4° C. and +50° C., or between +5° C. and +35° C.

One advantage of the mixture of component A and component B is that it quickly develops a dry surface.

It is possible to include further steps into processes in some embodiments. Such further steps typically are directed to further increase the performance of a porous construction material treated in a process as described above. According to embodiments, one or more further steps can be selected from cleaning the surface of the porous construction material, priming the surface (especially in cases where the construction material has a very high porosity), and application of further layers on top of the mixture of component A and component B.

In another aspect, embodiments of the present invention relate to a porous construction material, for example as part of a building, treated in a repairing process or a waterproofing process, as described above.

According to some embodiments, a porous construction material treated in a process as described above can be part of an outside structure which is subject to contact with water, for example caused by dew, rain, spray, and/or tides. According to further embodiments, a porous construction material treated in a process described above can be part of basement walls, floor structures, drainages, pipes, silos, stairs, bathrooms, kitchens, swimming pools, balconies, terraces, ponds or basins, harbor structures and works of civil engineering, e.g. tunnels.

In some embodiments, the process is suitable to be integrated in the construction of new structures and/or in the refurbishment of existing structures. It is, for example possible, to integrate a process as described herein into the construction of basement walls, floor structures, drainages, pipes, silos, stairs, bathrooms, kitchens, swimming pools, balconies, terraces, ponds or basins, harbor structures and works of civil engineering, e.g. tunnels.

In another aspect, embodiments of the present invention relates to a kit of parts suitable to form a repair material as described above or suitable to be used in a process for the waterproofing of porous construction materials as described above. The kit of parts is characterized in that it comprises or consists of a first component A and a second component B, said first component A comprising or consisting of (in each case relative to the total weight of component A)

a) 7-100% by weight, 10-55% by weight, or 16-36% by weight of a hydraulic binder,
b) 0-93% by weight, 45-90% by weight, or 66-80% by weight of aggregates, and said second component B comprising or consisting of
d) an aqueous emulsion of bitumen, and
e) at least one synthetic polymer in an amount of greater than 0 and lower than about 30% by weight, or between 3-25% by weight, preferably 8-20% by weight, especially 14-20% by weight, relative to the total weight of the component B.

The further details and embodiments as described above are also meant to apply in the case of a kit of parts of the present invention.

### EXAMPLES

### Example Composition

One example of a two-component repair material was prepared consisting of component A and component B having the compositions shown below.

Component A

| Material | W % |
|---|---|
| Ordinary Portland Cement Type I/II | 9.9 |
| Calcium aluminate cement (Ciment | 12.2 |
| Fondu®, Imerys Aluminates) | |
| Calcium sulfate (Anhydrite, Solvay) | 2.9 |
| Sand | 44.85 |
| Crushed aggregates (granite 89) | 30 |
| Li₂CO₃ | 0.1 |
| Tartric acid | 0.05 |

Component B

| Material | W % |
|---|---|
| Aqueous emulsion of synthetic polymer | 6 |
| (approximately 50% water, 50% solids | |
| styrene-acrylate copolymer, Tg 19° C.) | |
| Bitumen emulsion (55% bitumen, 45% | 90 |
| water, anionically stabilized) | |
| Pigment (magnesium ferrite) | 4 |

### Cracking Evaluation

As indicated above, previous testing has demonstrated that adding water to asphalt emulsions induces cracking in the finished product. The following tests were conducted to determine the effects of water that is added as part of the aqueous emulsion of synthetic polymer in component B.

In the following table, the bitumen emulsion is the 55% bitumen emulsion identified above. The “additional water” is the amount of water that is separately added to the mixture, or the amount of water that is added as part of adding the above-referenced aqueous emulsion of synthetic polymer in Component B (the water does not include water that is already present in the asphalt emulsion). For example, in test 2 Component B includes 20% of the aqueous emulsion, which corresponds to 50 additional parts water in this test.

The bitumen emulsion was mixed with the cementitious powder, and optionally with water or the aqueous emulsion of synthetic polymer, and the finished product was evaluated for cracking.

| | Ratio (bitumen emulsion*¹: | Additional water | |
|---|---|---|---|
| Test | additional water: component A) | source | Cracking |
| 1 | 495:55:1822 | Added water | Yes |
| 2 | 400:50:1822 | Aqueous emulsion | No |
| 3 | 424:53:1822 | Aqueous emulsion | No |
| 4 | 600:0:1822 | N/A | No |

*¹55% bitumen, 45% water, anionically stabilized

As can be seen form these experiments, water that is added to the mixture as part of an aqueous emulsion does not induce cracking, even though adding comparable amounts of water separately to the mixture will induce cracking.

### Mixability Evaluation

In connection with this disclosure, it was observed that the amount of aqueous emulsion that is added to the mixture can be a significant factor affecting whether the bitumen emulsion and cementitious material mix well. In this regard, small variations in the ratio of the bitumen to water in the bitumen emulsion, and small variations in the cementitious material (e.g., proportion of cement and aggregate) affected the mix consistency. Depending on these factors, the material could be too dry to be mixable, or could alternatively be too loose (i.e., too wet). Based on these factors, the inventors have observed that using an amount of the above-referenced aqueous emulsion in amounts of 13 w % or more (relative to Component B) tended to provide a more consistent material from batch to batch. More preferably, the amount of aqueous emulsion is 16 w % or more, such as from 16 w % to 20 w %. It is assumed that higher amounts of aqueous emulsion could be used without negative performance provided that the amount of bitumen emulsion is decreased somewhat. These experiments are shown in the table below.

| | Ratio (bitumen | w % aqueous | | |
|---|---|---|---|---|
| | emulsion*¹: | latex | | |
| | latex | emulsion*² | Batch 1 | Batch 2 |
| | emulsion*²: | (rel to | Mixability/ | Mixability/ |
| Test | component A) | Component B) | Quality | Quality |
| 1 | 600:0:1822 | 0 | Good/Good | Poor (mixes easily, |
| | | | | but too much |
| | | | | flow)/Poor |
| 2 | 550:0:1822 | 0 | Poor (does | Good/Good |
| | | | not mix, too | |
| | | | dry)/Poor | |
| 3 | 470:30:1822 | 6 | Good/Good | Good/Good |
| 4 | 450:50:1822 | 10 | Good/Good | Good/Good |
| 5 | 430:70:1822 | 14 | Good/Good | Good/Good |
| 6 | 420:80:1822 | 16 | Good/Good | Good/Good |
| 7 | 410:90:1822 | 18 | Good/Good | Good/Good |
| 8 | 400:100:1822 | 20 | Good/Okay | Good/Okay |

*¹55% bitumen, 45% water, anionically stabilized
*²Aqueous emulsion of synthetic polymer (approximately 50% water, 50% solids styrene-acrylate copolymer, Tg 19° C.

### Blushing Evaluation

Blushing was noticeable in the material when the aqueous emulsion of synthetic polymer is used in Component B. The use of inorganic oxide pigments such as iron oxide and manganese iron ferrite (a Complex Inorganic Colored Pigment) were found to reduce the amount of blushing and improve the rheology (higher viscosity and reduced settling), which creates a rougher texture on the surface of the finished product. These experiments are shown in the table below.

| | | w % aqueous | | | |
|---|---|---|---|---|---|
| | Ratio (bitumen | latex emulsion*² | | | |
| | emulsion*¹: | (rel to | Black | | |
| | latex emulsion*²: | Component | pigment | | |
| Test | component A) | B) | added | 24 hours | 1 week |
| 1 | 600:0:1822 | 0 | No | Brown, | Brownish |
| | | | | No | black, No |
| | | | | blushing | blushing |
| 2 | 430:70:1822 | 16 | No | Blushing | Excessive |
| | | | | | blushing |
| 3 | 600:0:1822 | 0 | Yes, | Brownish | Blackish |
| | | | Magnesium | black, no | brown, no |
| | | | Ferrite | blushing | blushing |
| | | | (NB-803K | | |
| | | | from Ferro) | | |
| 4 | 430:70:1822 | 16 | Yes, | Brownish | Blackish |
| | | | Magnesium | black, | brown, |
| | | | Ferrite | slight | slight |
| | | | (NB-803K | blushing | blushing |
| | | | from Ferro) | | |
| 5 | 430:70:1822 | 16 | Yes, | Brownish | Blackish |
| | | | Black | black, | brown, |
| | | | Iron Oxide | slight | slight |
| | | | (NB-5970 | blushing | blushing |
| | | | from | | |
| | | | Ferro) | | |

*¹55% bitumen, 45% water, anionically stabilized
*²Aqueous emulsion of synthetic polymer (approximately 50% water, 50% solids styrene-acrylate 2 copolymer, Tg 19° C.

### Bleeding Evaluation

Using too much bitumen emulsion was observed to lead to bleeding (forming a soft skin forming on the surface that wears easily) and tended to provide a product with poor rheology by virtue of being too thin, which can result in significant settling of aggregate. The inventors observed that the addition of aqueous emulsion of synthetic polymer can help to overcome this issue. The amount of aqueous emulsion of synthetic polymer can be indirectly proportional to the amount of bitumen emulsion, and when used in an ample amount (depending on the quality and ratio of ingredients used in the asphalt emulsion), the consistency of the mix or finished product is greatly improved. These experiments are shown in the table below.

| | | w % | | |
|---|---|---|---|---|
| | Ratio (bitumen | aqueous | | |
| | emulsion*¹: | latex | | |
| | latex | emulsion*² | Batch | Batch |
| | emulsion*²: | (rel to | 1 Skin | 2 Skin |
| Test | component A) | Component B) | formation | formation |
| 1 | 600:0:1822 | 0 | No | Yes, excessive |
| 2 | 550:0:1822 | 0 | No-did not | Yes, very slight |
| | | | mix, too dry | |
| 3 | 470:30:1822 | 6 | No | No |
| 4 | 450:50:1822 | 10 | No | No |
| 5 | 430:70:1822 | 14 | No | No |
| 6 | 420:80:1822 | 16 | No | No |
| 7 | 410:90:1822 | 18 | No | No |
| 8 | 400:100:1822 | 20 | Yes-very slight | Yes-very slight |
| | | | (acceptable) | (acceptable) |

*¹55% bitumen, 45% water, anionically stabilized
*²Aqueous emulsion of synthetic polymer (approximately 50% water, 50% solids styrene-acrylate 2 copolymer, Tg 19° C.

1. A two-component repair material comprising a first component A and a second component B,
the first component A comprising:
a) 7-100 w % of a hydraulic binder based on the total weight of the first component A, and
b) 0-93 w % of aggregates based on the total weight of the first component A, and
the second component B comprising:
d) an aqueous emulsion of bitumen, and
e) at least one synthetic polymer in an amount of greater than 0 and lower than about 30 w % based on the total weight of the second component B.

2. The two-component repair material of claim 1, wherein the hydraulic binder is selected from Portland cement, aluminate cement, calcium sulfoaluminate cement, a source of calcium sulfate, natural hydraulic lime, slag, pozzolanes, and mixtures thereof.

3. The two-component repair material of claim 1, wherein the hydraulic binder comprises:
a1) 2-100 parts by mass of Portland Cement;
a2) 5-150 parts by mass of aluminate cement; and
a3) 1-20 parts by mass of a source of calcium sulfate.

4. The two-component repair material of claim 3, wherein the source of calcium sulfate is anhydrite.

5. The two-component repair material of claim 1, wherein the aqueous emulsion of bitumen is an anionic aqueous emulsion having approximately 10-75 w % of asphalt or bitumen binder.

6. The two-component repair material of claim 1, wherein the second component B includes greater than about 70 w % of the aqueous emulsion of bitumen.

7. The two-component repair material of claim 1, wherein the second component B additionally comprises at least one additive selected from the group consisting of a surfactant, a clay, a stabilizer, a rheology modifier, and a pen modifier.

8. The two-component repair material of claim 1, wherein the aggregates are selected from sand, crushed rock, limestone flour, lightweight aggregate, especially slate, pumice, or ground rubber, or mixtures thereof.

9. The two-component repair material of claim 1, wherein the first component A and/or the second component B includes a pigment.

10. A mixture of a first component A and a second component B,
the first component A comprising:
a) 7-100 w % of a hydraulic binder based on the total weight of the first component A, and
b) 0-93 w % of aggregates based on the total weight of the first component A, and
the second component B comprising:
d) an aqueous emulsion of bitumen, and
e) at least one synthetic polymer in an amount of greater than 0 and lower than about 30 w % based on the total weight of the second component B,
wherein the mixture includes a mix ratio of the first component A and the second component B such that the mixture comprises approximately 10-45 w % of the hydraulic binder.

11. A process for treating a porous construction material, the process comprising:
(i) providing a first component A and a second component B, in which the first component A comprises:
a) 7-100 w % of a hydraulic binder based on the total weight of the first component A, and
b) 0-93% w % aggregates based on the total weight of the first component A, and
and the second component B comprises:
d) an aqueous emulsion of bitumen, and
e) at least one synthetic polymer in an amount of greater than 0 and lower than about 30 w % based on the total weight of the second component B;
(ii) mixing the first component A and the second component B to obtain a mixture; and
(iii) applying the mixture to the porous construction material.

12. The process of claim 11, further comprising hardening the mixture after it is applied to the porous construction material.

13. The process of claim 11, wherein the hydraulic binder comprises:
a1) 2-100 parts by mass of Portland Cement,
a2) 5-150 parts by mass of aluminate cement, and
a3) 1-20 parts by mass of a source of calcium sulfate,
and the aqueous emulsion of bitumen is an anionic aqueous emulsion of bitumen, and component B comprises the anionic aqueous emulsion of bitumen in an amount of greater than about 70 w % based on total weight of the second component B.

14. A construction material that is treated according to the process in claim 11.

15. A kit comprising a first container that includes a first component A, and a second container that includes a second component B,
the first component A comprising:
a) 7-100 w % of a hydraulic binder based on the total weight of the first component A, and
b) 0-93 w % of aggregates based on the total weight of the first component A, and
the second component B comprising:
d) an aqueous emulsion of bitumen, and
e) at least one synthetic polymer in an amount of greater than 0 and lower than about 30 w % based on the total weight of the component B.
